(19) United States
(12) Patent Application Publication
(10) Pub. No.: US 2021/0219561 A1
(43) Pub. Date: Jul. 22, 2021

(54) Apparatus and Method for Making Food Items

(71) Applicant: Garland Ventures, Ltd, Garland, TX (US)

(72) Inventors: Leon KC Hsu, Garland, TX (US); James T. Jiang, Plano, TX (US)

(21) Appl. No.: 16/748,794

(22) Filed: Jan. 21, 2020

(51) Int. Cl. A21D 13/31; A23L 19/12; A23L 3/365; A23P 30/20; A23P 20/20; A23P 30/10; A23L 13/00; A21D 13/38

(52) U.S. Cl. CPC A21D 13/31; A23L 19/13; A23L 3/365; A23P 30/20; A23V 2002/00; A23P 30/10; A23L 13/06; A21D 13/38; A23P 20/20

(57) ABSTRACT

Apparatus and method for making a food items such as a shepherd's pies is disclosed. The method includes preparing, cooking and cooling a pie filling, placing a predetermined amount of individual serving portions of the cooled pie filling into a container, preparing and cooking mashed potatoes, and extruding a predetermined individual serving portion of the mashed potatoes into each of a plurality of compartments formed in a mold tray, the compartments having a predetermined shape and depth. The pie filling and the mashed potatoes in the mold tray compartments are then frozen for storage and transportation. The shepherd's pies can then be assembled and baked at the point-of-sale.

### FIELD

The present disclosure relates to apparatus and method for making frozen prepared foods, and in particular, to apparatus and method for making food items such as shepherd's pies for fresh-made food service.

### BACKGROUND

Competition for consumers' food budget is heating up more than ever before. While fast food and fast casual chains grab large portions of the market share, supermarket delis are looking to expand their fresh-prepared food menus. Going beyond old stand-by of fried chicken and potato salad, supermarket deli counters want to offer more varieties of food offerings prepared from scratch that are healthier options.

### BRIEF DESCRIPTION OF THE DRAWINGS

FIGS. 1 and 2 are top and bottom perspective views of an embodiment of a mashed potato disc mold tray according to the teachings of the present disclosure;

FIGS. 3 and 4 are top and bottom plan views of an embodiment of a mashed potato disc mold tray according to the teachings of the present disclosure;

FIGS. 5 and 6 are side elevational views of an embodiment of a mashed potato disc mold tray according to the teachings of the present disclosure;

FIG. 7 is a schematic diagram of a process of extruding mashed potato onto the mold tray according to the teachings of the present disclosure;

FIG. 8 is a perspective view of the two components of shepherd's pies according to the teachings of the present disclosure;

FIG. 9 is a flowchart of an embodiment of a method to prepare and assemble shepherd's pies according to the teachings of the present disclosure;

FIG. 10 shows a pin tin filled with pie filling with a mashed potato disc prior to assembly according to the teachings of the present disclosure; and

FIG. 11 shows an assembled and baked shepherd's pie according to the teachings of the present disclosure.

### DETAILED DESCRIPTION

To expand their food offerings, supermarket delis look for fresh-made items that can be prepared with consistency by relatively unskilled personnel. Frozen food items that have been prepared off-site, then easily assembled on-site and cooked are ideal. The shepherd's pie, a minced meat-and-vegetable pie with a topping of mashed potatoes, combining meat, vegetables, and starch, is an all-in-one food item that would expand a deli's menu and satisfy today's consumers' desire for fast and healthy meals. The methodology described herein can be used to produce any food item where a food has been grounded, pressed, blended, shredded, or sieved to achieve a creamy paste or soft cohesive consistency.

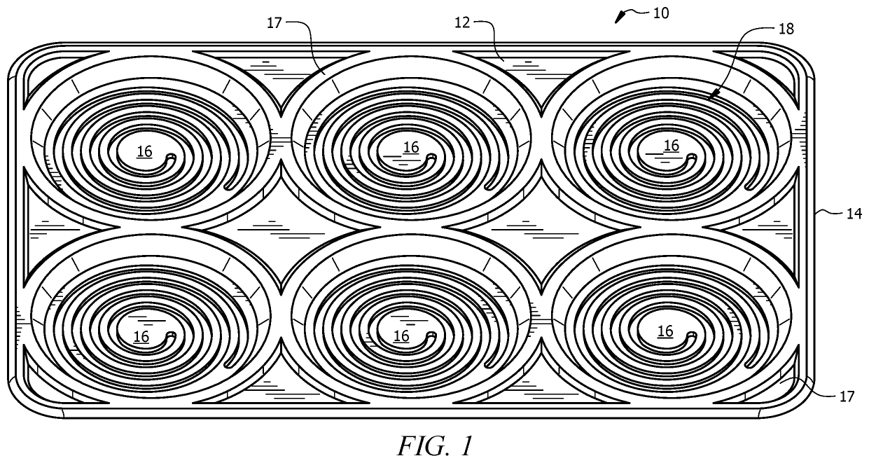

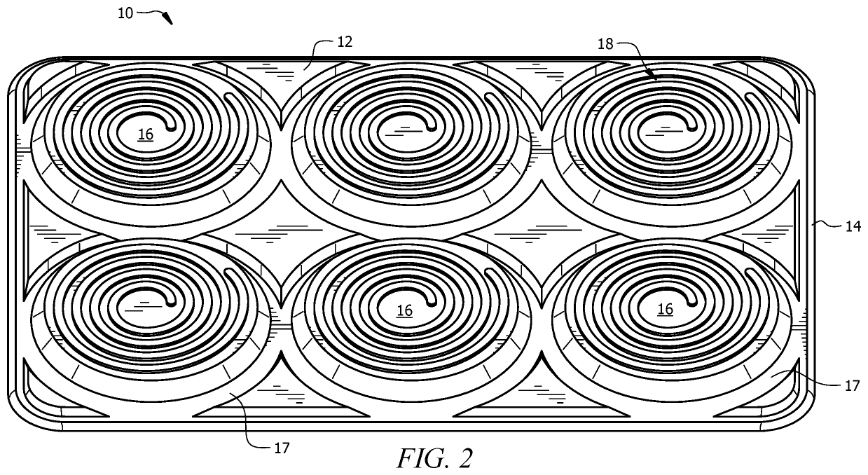

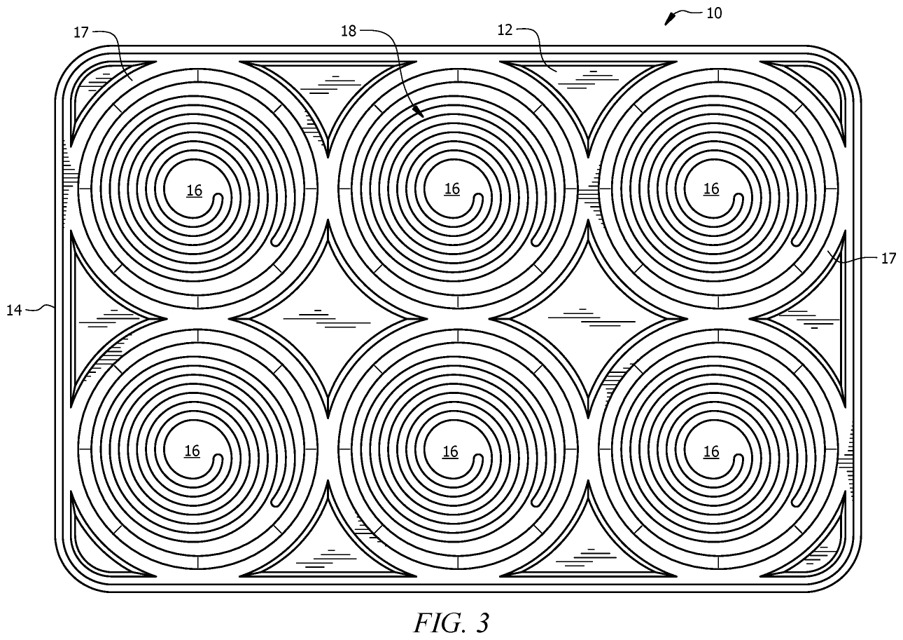

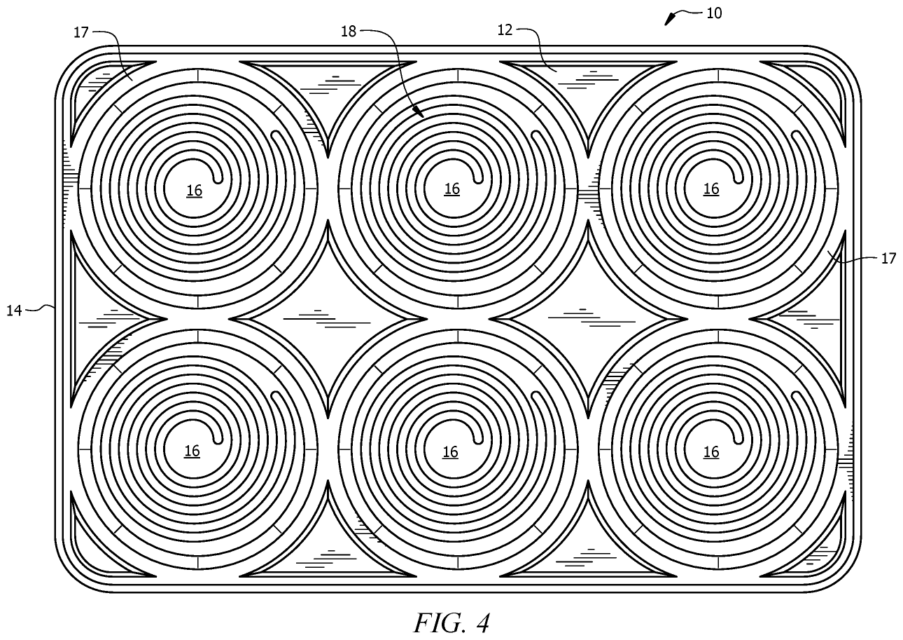

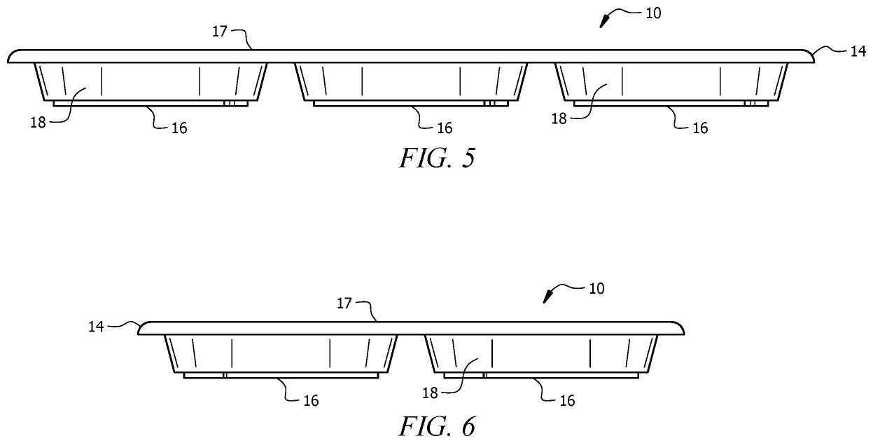

FIGS. 1-6 are various views of an embodiment of a mold tray 10 used to form a mashed potato discs (a topper food item) that top individual portions of shepherd's pies. The mold tray 10 is a one-piece tray that includes a planar tray body 12 with a reinforcing lip 14 around the entire peripheral edge of the tray 10 to provide added structural stiffness and integrity. The tray 10 further incorporates multiple divided molding compartments 16 of a predetermined depth and circular in shape. The circumferential edge of each molding compartment may also be reinforced by a lip 17 that provides more structural rigidity. The upward-facing bottom surfaces of the molding compartments 16 are preferably planar and may incorporate an indented or protruding pattern, such as a spiral design as shown, or a logo or another design element 18. The tray 10 is preferably constructed of a food-grade plastic material that have sufficient structural integrity and rigidity to support the mashed potato held within the molding compartments 16. The stiffness of the tray 10 is aided in using the reinforcing lip 14 and other structural reinforcements as known in the art.

Alternatively, the upward-facing bottom surface of each molding compartment may have alternate shapes, such as square, rectangular, triangular, star, etc. Additionally, the shape of the molding compartment may be a shape other than a cylindrical volume, but can be any desirable shape. The compartment may have a bottom shape that is different than the opening of the compartment. For example, the bottom of the compartment may be star-shaped and the shape of the compartment opening may be circular-shaped. The resultant molded mashed potato would take on the shape of the compartment. The bottom surface of the molding compartment may additionally incorporate design elements consistent with, for example, themes, seasons, or holidays. Further, the molding compartments may be organized and arranged in the tray in any desirable manner. For example, the molding compartments may be arranged in a single row, staggered rows, or a matrix (rows and columns) of any size. The plastic material used to fabricate the mold tray may be a single-use or recyclable material. The plastic material may be microwaveable.

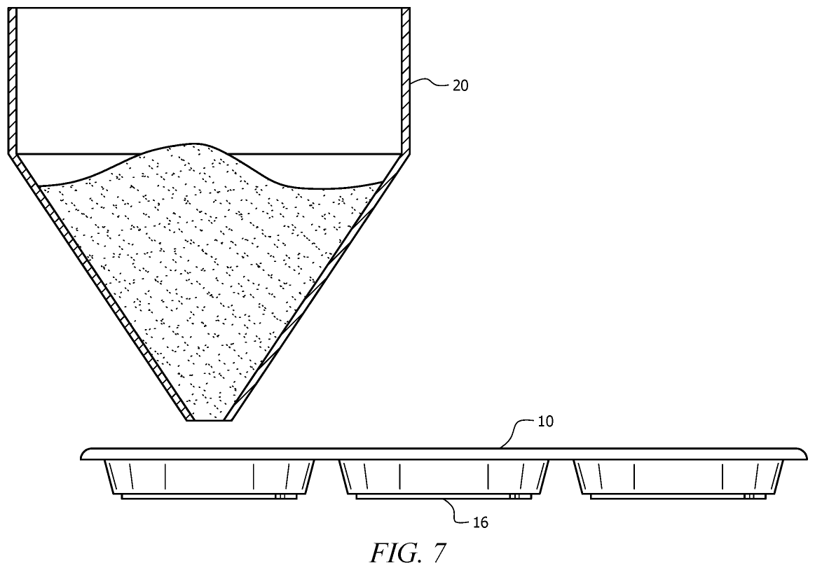

Referring to FIG. 7, a measured portion of mashed potatoes can be deposited by an extruder 20 into each molding compartment 16 in the mold tray 10. In an automated manufacturing plant, the mold trays 10 may be placed on a conveyor (not shown) that moves them sequentially below one or more extruders, so that the molding compartments 16 may be filled with measured portions of mashed potatoes in a systematic and expedient manner.

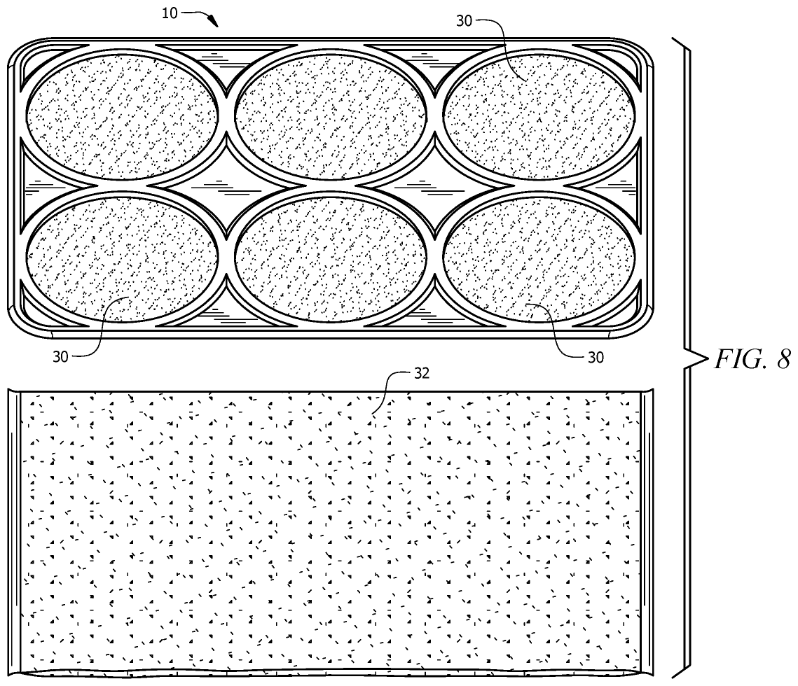

FIG. 8 shows a mold tray 10 with mashed potato that has been frozen into discs 30 with a plastic container or bag of shepherd's pie filling 32. The amount of pie filling in the plastic bag is for the number of mashed potato discs contained in each mold tray. For example, the mold tray 10 holding six mashed potato discs 30 is sold as a unit with a bag 32 containing pie filling that has been portioned for six shepherd's pies.

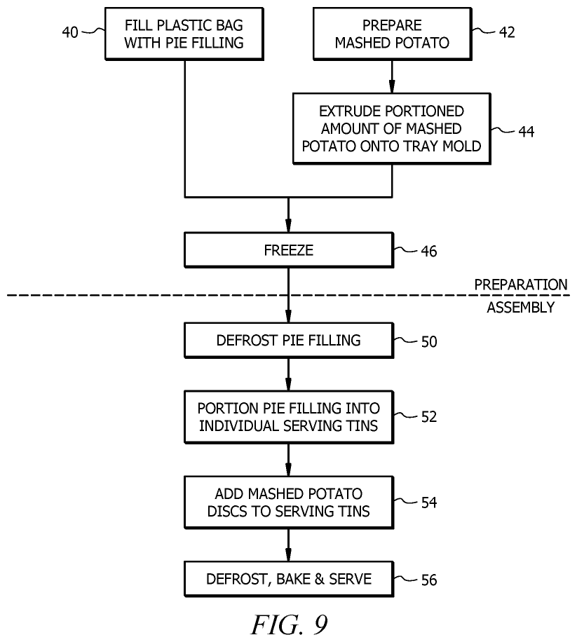

FIG. 9 is a flowchart of an embodiment of a method to prepare and assemble shepherd's pies according to the teachings of the present disclosure. The pie filling is cooked and cooled, and the filling is put into the plastic bags and sealed, as shown in block 40. In blocks 42 and 44, mashed potatoes are prepared, cooked, and extruded in portioned amount into the molding compartments of mold trays. The mashed potato fills the molding compartments including design patterns at the bottom surfaces of the molding compartments. The mashed potato in the molding compartments conforms to the shape of the molding compartment and is formed into discs as it is frozen for storage and shipment, as shown in block 46. The bag of pie filling is frozen as well for storage and shipment. As mentioned above, each bag of pie filling and each tray of mashed potato discs are sold as a unit.

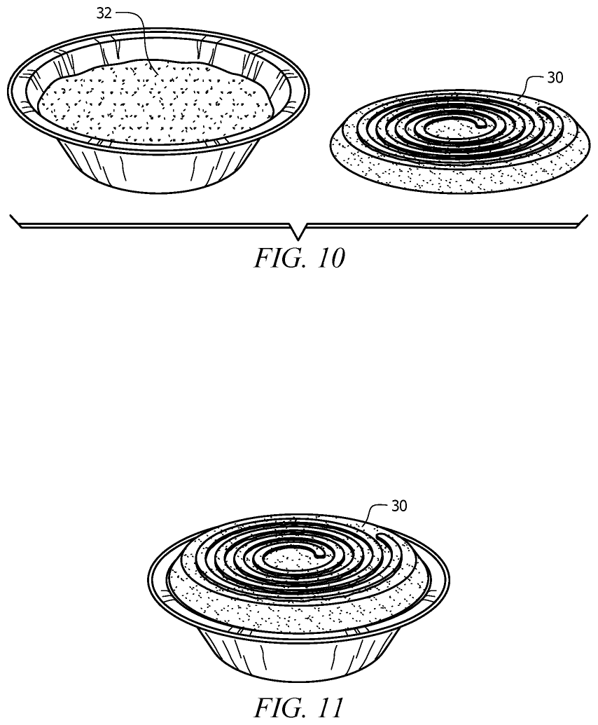

At the point of sale, such as a supermarket deli, one or more bags of frozen pie filling are defrosted or partially defrosted for a predetermined amount of time, as shown in block 50. The pie filling is then removed from the plastic bags and portioned amounts are put into serving-size pie tins, as shown in block 52. The mashed potato discs are then removed from the mold trays and put on top of the pie filling in each pie tin, as shown in block 54. FIG. 10 shows a pin tin filled with pie filling with a mashed potato disc prior to assembly. The assembled shepherd's pies are then allowed to rest so that the frozen potato discs are allowed to defrost to shorten the bake time. Programmable ovens may then be used to bake the shepherd's pie and be served, as shown in block 56. The application of heat in the oven allows the mashed potato to form a crust on top of the pie filling and slightly darken the protruding design pattern compared to the surrounding crust surface. FIG. 11 shows an assembled and baked shepherd's pie.

It should be noted that the mold tray described herein can be used to mold and form any type of ingredient that may be used to be combined or assembled with one or more other ingredients or portions of a food item. The methodology described herein can be used to produce any food item that has a topper food item where a substance has been grounded, pressed, blended, shredded, or sieved to achieve a creamy paste or soft cohesive consistency. The topper food item can be/include starchy tubers, vegetables, dairy products, and meat-based products, as long as they can be processed to a consistency that can flow out of an extruder and deposited onto the tray mold for freezing.

The features of the present invention which are believed to be novel are set forth below with particularity in the appended claims. However, modifications, variations, and changes to the exemplary embodiments described above will be apparent to those skilled in the art, and the apparatus and method for making food items for the fresh-made market described herein thus encompasses such modifications, variations, and changes and are not limited to the specific embodiments described herein.

What is claimed is:

1. A method for making a food product, the method comprising:
preparing, cooking and cooling a pie filling;
placing a predetermined amount of individual serving portions of the cooled pie filling into a container;
preparing and cooking a topper food item;
extruding a predetermined individual serving portion of the topper food item into each of a plurality of compartments formed in a mold tray, the compartments having a predetermined shape and depth; and
freezing the pie filling and freezing the topper food item in the mold tray compartments.

2. The method of claim 1, wherein extruding the predetermined individual serving portion of the topper food item comprises extruding mashed potatoes into each of a plurality of compartments formed in a mold tray, the compartments being circular in shape.

3. The method of claim 1, wherein extruding the predetermined individual serving portion of the topper food item comprises extruding mashed potatoes into each of a plurality of compartments formed in a mold tray, the compartments having a bottom surface incorporating an indented design pattern.

4. The method of claim 1, wherein extruding the predetermined individual serving portion of the topper food item comprises extruding mashed potatoes into each of a plurality of compartments formed in a mold tray, the compartments having a bottom surface incorporating a design pattern.

5. The method of claim 1, wherein extruding the predetermined individual serving portion of the topper food item comprises extruding mashed potatoes into each of a plurality of compartments formed in a mold tray, the compartments incorporating a circumferential reinforcing lip.

6. The method of claim 1, wherein extruding the predetermined individual serving portion of the topper food item comprises extruding mashed potatoes into each of a plurality of compartments formed in a mold tray having a reinforcing peripheral edge that provides added structural integrity.

7. The method of claim 1, wherein extruding the predetermined individual serving portion of the topper food item comprises extruding mashed potatoes into each of a plurality of compartments formed in a mold tray constructed of one of a single-use plastic and a recyclable plastic.

8. The method of claim 1, wherein extruding the predetermined individual serving portion of the topper food item comprises extruding mashed potatoes into each of a plurality of compartments formed in a mold tray, the compartments having a planar circular bottom surface incorporating a design pattern configured to form an outline of the design pattern onto a surface of the mashed potato disc molded by the compartment.

9. The method of claim 1, further comprising:
at least partially defrosting the container of the pie filling;
placing individual serving portions of the defrosted pie filling into pie tins;
adding a frozen individual serving portion of the topper food item on top of the pie filling in each pie tin to assemble each shepherd's pie, wherein the topper food items are frozen individual serving portions of mashed potato;
at least partially defrosting the shepherd's pies; and
baking the shepherd's pies for a predetermined amount of time.

10. A method for making a plurality of mashed potato-topped meat pies, the method comprising:
cooking a meat-based pie filling;
placing a predetermined amount of individual serving portions of the pie filling into a plastic bag;
preparing mashed potatoes;
placing an individual serving portion of the mashed potatoes into each of a plurality of circular-shaped compartments arranged and formed in a plastic mold tray; and
freezing the pie filling and freezing the mashed potatoes in the mold tray compartments.

11. The method of claim 10, wherein placing the predetermined individual serving portion of the mashed potatoes comprises extruding the mashed potatoes into each of a plurality of compartments formed in a mold tray, the compartments having a bottom surface incorporating an indented design pattern.

12. The method of claim 10, wherein placing the predetermined individual serving portion of the mashed potatoes comprises extruding the mashed potatoes into each of a plurality of compartments formed in a mold tray, the compartments incorporating a circumferential reinforcing lip.

13. The method of claim 10, wherein placing the predetermined individual serving portion of the mashed potatoes comprises extruding the mashed potatoes into each of a plurality of compartments formed in a mold tray having a reinforcing peripheral edge that provides added structural integrity.

14. The method of claim 10, wherein placing the predetermined individual serving portion of the mashed potatoes comprises extruding the mashed potatoes into each of a plurality of compartments formed in a mold tray constructed of one of a single-use plastic and a recyclable plastic.

15. The method of claim 10, wherein placing the predetermined individual serving portion of the mashed potatoes comprises extruding the mashed potatoes into each of a plurality of compartments formed in a mold tray, the compartments having a planar circular bottom surface incorporating a design pattern configured to form an outline of the design pattern onto a surface of the mashed potato disc molded by the compartment.

16. The method of claim 10, further comprising:
at least partially defrosting the plastic bag of the pie filling;
putting individual serving portions of the defrosted pie filling into pie tins;
adding a frozen individual serving portion of mashed potato on top of the pie filling in each pie tin to assemble each meat pie;
at least partially defrosting the meat pies; and
baking the meat pies for a predetermined amount of time.

17. A food item, comprising:
a meat-based pie filling; and
a topping made by freezing a cooked food item extruded into a plurality of individual portion-sized compartments arranged and formed in a mold tray.

18. The shepherd's pie of claim 17, wherein the cooked food item topping is made by freezing cooked mashed potato extruded into a plurality of individual portion-sized circular compartments arranged and formed in a mold tray.

19. The shepherd's pie of claim 17, wherein the cooked food item topping is made by freezing cooked mashed potato extruded into a plurality of individual portion-sized compartments arranged and formed in a mold tray, the compartments having a bottom surface incorporating a design pattern configured to imprint a protruding design in a surface of the mashed potato topping.

20. The shepherd's pie of claim 17, wherein the cooked food item topping is made by freezing cooked mashed potato extruded into a plurality of individual portion-sized compartments arranged and formed in a mold tray incorporating reinforcing structural edging to provide added structural integrity and rigidity.
